(19) United States
(12) Patent Application Publication
(10) Pub. No.: US 2013/0065138 A1
(43) Pub. Date: Mar. 14, 2013

(54) METHOD FOR NEGATIVE ELECTRODE ACTIVE MATERIAL EVALUATION AND NEGATIVE ELECTRODE ACTIVE MATERIAL

(71) Applicants: Koji Takahata, Toyota-shi (JP); Kaoru Inoue, Hirakata-shi (JP)

(72) Inventors: Koji Takahata, Toyota-shi (JP); Kaoru Inoue, Hirakata-shi (JP)

(21) Appl. No.: 13/698,366

(22) PCT Filed: May 18, 2010
(86) PCT No.: PCT/JP2010/058387

§ 371 Date: Nov. 16, 2012

(51) Int. Cl. H01M 10/0566; H01M 4/583; G01J 3/44

(52) U.S. Cl. 429/338; 356/301; 429/231.8

(57) ABSTRACT

Provided is a method for negative electrode active material evaluation useful for steady production of batteries having a prescribed performance level. This evaluation method comprises: (A) running microscopic Raman analysis at a wavelength of 532 nm n times on a sample of a composite carbon comprising a low-crystalline carbon material at least partially on surfaces of particles of a high-crystalline carbonaceous substance (wherein n is 20 or more); (B) with respect to a Raman spectrum obtained in each microscopic Raman analysis run, determining the ratio of its D-band intensity I_{D} to its G-band intensity I_{G}, R (I_{D}/I_{G}); (C) determining the number of analysis runs, m, where the R value was 0.2 or greater, and (D) determining the ratio of m to n, the total number of analysis runs.

### TECHNICAL FIELD

The present invention relates to a negative electrode active material for batteries such as lithium-ion secondary batteries and others.

### BACKGROUND ART

A lithium-ion secondary battery comprises a positive electrode, a negative electrode, and an electrolyte present between these two electrodes; and charging and discharging are mediated by lithium ions in the electrolyte moving back and forth between the two electrodes. Its negative electrode comprises a negative electrode active material that is able to reversely store and release lithium ions, and as such a negative electrode active material, various pulverized carbon materials are mainly used. Technical literatures relating to a negative electrode material for lithium-ion secondary batteries include Patent Document 1.

### CITATION LIST

### Patent Literature

[Patent Document 1] Japanese Patent Application Publication No. 2004-139743

### SUMMARY OF INVENTION

### Technical Problem

Usage of lithium-ion secondary batteries has been growing in various fields, and because their performances (charge-discharge characteristics, durability, etc.) are significantly affected by the negative electrode performance, improvement and stabilization of the negative electrode performance have been desired. As a negative electrode active material to form a high-performance negative electrode, for instance, have been investigated composite carbons in which a low-crystalline carbon material is deposited on surfaces of particles of a high-crystalline carbonaceous substance. However, according to the investigation by the present inventor, when such a negative electrode active material is used, it has been difficult to steadily obtain batteries giving an intended maximum charging current density (a maximum charging current density that can be applied without a significant capacity loss) and/or a targeted high-temperature storage stability at a charged state, and significant deviations have been likely to occur among batteries (typically, among batteries constructed with negative electrode active materials of different lots).

One objective of the present invention is to provide a method for evaluating a negative electrode active material, which is useful in a steady production of batteries with a desired performance. Another objective of the present invention is to provide a negative electrode active material that allows a steady production of high-performance batteries.

### Solution to Problem

With respect to composite carbons as negative electrode active materials, the present inventors found an index that allowed detection of differences in the surface activities that had not been distinguished by known parameters.

The present invention provides a method for evaluating, as a negative electrode active material, a composite carbon comprising a low-crystalline carbon material at least partially on surfaces of particles of a high-crystalline carbonaceous substance. This method comprises (A) running microscopic Raman analysis at a wavelength of 532 nm n times on a sample of such a negative electrode active material (wherein n is 20 or more). This method also comprises (B) with respect to a Raman spectrum obtained in each microscopic Raman analysis run, determining the ratio of its D-band intensity I_{D} to its G-band intensity I_{G}, R (I_{D}/I_{G}). This method further comprises (C) determining the number of analysis runs, m, where the R value was equal to or greater than 0.2; and (D)) as the distribution of R values equal to or greater than 0.2 (D_{R≧0.2}), determining the ratio of m to the total number of analysis runs, n, (m/n). The D-band is a Raman peak that appears around 1360 cm⁻¹ due to vibrations of poorly conjugated (continuous) sp²C-sp²C bonds. The G-band is a Raman peak that appears around 1580 cm⁻¹ due to vibrations of highly conjugated sp²C-sp²C bonds. As the respective band intensities, peak-top values modified by setting the base line to zero are used, respectively.

The present method for negative electrode active material evaluation is applied to particles of a high-crystalline carbonaceous substance (composite carbon) having a low-crystalline carbon material on surfaces thereof. The term, low-crystalline carbon material (which hereinafter may be referred to as non-crystalline carbon), refers to a carbon material of low crystallinity such as amorphous carbons and so on. The term, high-crystalline carbonaceous substance (which hereinafter may be referred to as a graphitic substance), refers to a carbon material having a highly-organized layered crystal structure, such as graphite and so on. The R value of a general graphitic substance may be smaller than 0.2.

In charging of a lithium-ion secondary battery especially at a low temperature (e.g., around 0° C.), when the charging current density is excessively high relative to the battery performance, lithium may precipitate out on the negative electrode surface, giving rise to a defect of a significant performance loss. In order to avoid such a defect, increasing the maximum charging current density (mA/cm²) is desirable. The maximum charging current density tends to increase as the rate of the electrochemical reaction at the negative electrode increases, and the rate of the electrochemical reaction increases as the active area for lithium ion intercalation is larger, given that the crystal structure remains approximately the same. On the other hand, when a battery is stored (left) at a charged state, especially at a high temperature (e.g., around 60° C.), side reactions in which electrolyte components are reductively decomposed at the negative electrode progress, giving rise to a defect of a significant capacity loss. In general, the activity toward such a side reaction is high in an area that is highly active for lithium ion intercalation. Therefore, the high-temperature storage stability at a charged state tends to decrease as the active area for lithium ion intercalation increases. In order to achieve a good balance of these two opposing properties, the activity of a negative electrode active material needs to be highly controlled.

In a composite carbon, of its surfaces, lithium ion intercalation takes place on areas coated with the non-crystalline carbon as well as edge surfaces and exposed broken areas (i.e., low-crystalline areas) of the graphitic substance, but not on areas of exposed basal planes (i.e., high-crystalline areas) of the graphitic substance. The activity toward a side reaction tends to be high in the low-crystalline areas, but low in the high-crystalline areas. Therefore, activities toward lithium ion intercalation and side reactions do not always correspond to the mere specific surface area. Because of this, for example, even in batteries made with composite carbons having similar specific surface areas, some variations may occur at least among either their maximum charging current densities or their high-temperature storage stabilities.

According to microscopic Raman spectroscopy, low-crystalline areas (areas coated with a non-crystalline carbon, edge surfaces (edges of crystals) and broken areas of a graphitic substance) and high-crystalline areas (basal planes (network planes of graphene sheets formed of hexagonal nets of conjugated sp²C's) of a graphitic substance) can be detected as the above-described D-band and the G-band, respectively. In this evaluation method, with respect to a single sample, microscopic Raman analysis is run 20 times or more on randomly-selected parts of the compose composite carbon that are different every time; and therefore, statistical data including variations among particles are obtained. Hence, according to this evaluation method, a negative electrode active material as a group of particles of a composite carbon can be evaluated with consideration for differences in the crystallinities on the surfaces. Such an evaluation method can be used, for instance, in detecting the state (uniformity, etc.) of the non-crystalline carbon coating on the particle surfaces of each composite carbon. Alternatively with respect to composite carbons of several different lots, differences can be detected in the activities that have not been detected by known parameters and the method can be used in sorting out those having higher activities or those less likely to achieve target activities. Based on these applications, the evaluation method is useful for steady production of lithium-ion secondary batteries with prescribed performance.

The present invention provides a negative electrode active material formed of the composite carbon characterized by that the distribution of R values equal to or greater than 0.2 (D_{R≧0.2}) is 20% or greater. According to such a negative electrode active material, lithium-ion secondary batteries can be more steadily formed to have prescribed performance (especially, maximum charging current density at a low temperature and high-temperature storage stability).

In an embodiment of the negative electrode active material disclosed herein, its nitrogen adsorption specific surface area is in a range of 4 m²/g to 9 m²/g. Such a negative electrode active material allows steady fabrication of lithium-ion secondary batteries having a better balance of maximum charging current density at a low temperature and high-temperature storage stability.

Therefore, in yet another aspect, the present invention provides a lithium-ion secondary battery that comprises a negative electrode comprising a negative electrode active material disclosed herein, a positive electrode comprising a positive electrode active material, and a non-aqueous electrolyte solution. Such a battery may have a highly-controlled negative electrode performance and steadily produce prescribed performance (low-temperature maximum charging current density, high-temperature storage stability).

In an embodiment of the lithium-ion secondary battery disclosed herein, the non-aqueous electrolyte solution comprises vinylene carbonate (VC). Such a battery may have a greater high-temperature storage stability.

As described above, the lithium-ion secondary battery disclosed herein may combine well-balanced, high levels of low-temperature maximum charging current density, which is important in dealing with rapid charging and discharging, and durability against storage or usage at a high temperature (high-temperature storage stability). Such a battery is preferable, for instance, as an electric power used in a vehicle that may be used or stored (left) in a broad range of temperatures. Thus, the present invention provides a vehicle comprising a lithium-ion secondary battery disclosed herein. Preferable is a vehicle (e.g., an automobile) comprising such a lithium-ion secondary battery as a power source (typically, a power source of a hybrid vehicle or an electric vehicle).

### BRIEF DESCRIPTION OF DRAWINGS

FIG. 1 shows a perspective view schematically illustrating the shape of a lithium-ion secondary battery according to one embodiment.

FIG. 2 shows a cross-sectional view taken along the line II-II in FIG. 1.

FIG. 3 shows a graph plotting the maximum charging current densities against the specific surface areas with respect to the lithium-ion secondary batteries according to Examples 1 to 7.

FIG. 4 shows a side view schematically illustrating a vehicle (an automobile) comprising a lithium-ion secondary battery according to the present invention.

FIG. 5 shows a perspective view schematically illustrating the shape of a 18650 lithium-ion battery.

### DESCRIPTION OF EMBODIMENTS

Preferred embodiments of the present invention are described below. Matters necessary to practice this invention other than those specifically referred to in this description may be understood as design matters to a person of ordinary skills in the art based on the conventional art in the pertinent field. The present invention can be practiced based on the contents disclosed in this description and common technical knowledge in the subject field.

The method for negative electrode active material evaluation disclosed herein can be applied to a negative electrode active material formed of a composite carbon in which a non-crystalline carbon is deposited at least partially on surfaces of particles of a graphitic substance as a core material.

This evaluation method comprises the following steps (A) to (D):

(A) running microscopic Raman analysis at a wavelength of 532 nm n times on a sample of such a negative electrode active material (wherein n is 20 or more);
(B) with respect to a Raman spectrum obtained in each microscopic Raman analysis run, determining the ratio of its D-band intensity I_{D} to its G-band intensity I_{G}, R (I_{D}/I_{G});
(C) determining the number of analysis runs, m, where the R value is equal to or greater than 0.2; and
(D) as the distribution of R values equal to or greater than 0.2 (D₂), determining the ratio of m to the total number of analysis runs, n, (m/n).

The microscopic Raman analysis can be run n times on the same example using a microscopic laser Raman spectrometer with a high spatial resolution (e.g., 2 μm or smaller). In typical, after completion of each analysis run, the sample is tapped or its orientation is slightly moved for the next run so that different parts are analyzed every time. As the spectrometer, can be used, for instance, model “Nicolet Almega XR” available from Thermo Fisher Scientific, Inc., or a similar product. When the spatial resolution is too low (i.e., the minimum distance is too large), variations among particles are less likely to be reflected on the R values and the sensitivity of the evaluation may decrease.

The number of microscopic Raman analysis runs (n) should be 20 or more. The number of analysis runs is preferably 50 or more, or more preferably 75 or more. Although the upper limit of the number of analysis runs is not particularly limited, it can be around 125. When the number of analysis runs is too few, the sensitivity of the results of evaluation on a negative electrode active material may not be sufficient and therefore, desired negative electrode performance (maximum charging current density, high-temperature storage stability, etc.) may be less likely to be obtained.

This method for negative electrode active material evaluation can be applied to a negative electrode active material formed of a composite carbon. Such a negative electrode active material can be formed by depositing and carbonizing a coating material (coating substance) that is able to form non-crystalline carbon films on surfaces of particles of a graphitic substance (core material).

As the core material, can be used various kinds of graphite such as natural graphite, synthetic graphite, etc., processed (pulverized, spherically shaped) into particles (spheres). The core material preferably has an average particle diameter of about 6 μm to 20 μm. It preferably has a specific surface area (before coating) of about 5 m²/g to 15 m²/g. As a method for processing various kinds of graphite into particles, a conventional method can be employed without particular limitations.

As the coating material, depending on the method employed for forming a non-crystalline coating, a suitable material to form a carbon film can be selected for use. As the coating formation method, can be suitably employed a conventional method including, for instance, a gas phase method such as the CVD (chemical vapor deposition) method where a coating material in gas phase is vapor-deposited on surfaces of a core material (graphitic substance particles) under an inert gas atmosphere; a liquid phase method where after mixing a core material with a solution prepared by diluting a coating material with a suitable solvent, under an inert gas atmosphere, the coating material is sintered and carbonized; a solid phase method where a core material and a coating material are mixed without a solvent, and then, under an inert gas atmosphere, the coating material is sintered and carbonized; and so on.

As a coating material for the CVD method, can be used a compound (gas) that is able to form carbon films on the core material surfaces when decomposed by heat, plasma, or the like. Examples of such a compound include various hydrocarbon compounds such as aliphatic unsaturated hydrocarbons including ethylene, acetylene, propylene, etc.; aliphatic saturated hydrocarbons including methane, ethane, propane, etc.; aromatic hydrocarbons including benzene, toluene, naphthalene, etc.; and so on. Of these compounds, one kind can be used solely, or a mixed gas of two or more kinds can be used. The temperature, pressure, time, etc., for carrying out the CVD process can be suitably selected in accordance with the kind of coating material to be used and the desired amount of the coating.

As a coating material for a liquid phase method, can be used a compound that is soluble in a variety of solvents and is able to form carbon films on the core material surfaces when thermally decomposed. Preferable examples include pitches such as coal tar pitch, petroleum pitch, wood tar pitch, and so on. These can be used singly or in combination of two or more kinds. The temperature and time for sintering can be suitably selected in accordance with the kind, etc., of the coating material so that non-crystalline carbon films are formed. In typical, sintering may be carried out in a range of about 800° C. to 1600° C. for 2 to 3 hours.

As a coating material for a solid phase method, can be used one kind, or two or more kinds of the same coating materials as those for the liquid phase method. The temperature and time for sintering may be suitably selected in accordance with the kind of coating material. For instance, they can be in the same ranges as for the liquid phase method.

When employing any coating method, where necessary, various additives (e.g., additives effective in formation of a non-crystalline carbon from the coating material, or others) can be added to the coating material.

The amount of non-crystalline carbon coating in the composite carbon can be about 0.5 to 8% by mass (preferably 2 to 6% by mass). When the amount of coating is too small, the properties (low self-discharge, etc.) of the non-crystalline carbon may not be sufficiently reflected in the negative electrode performance. When the amount of coating is too large, because Li ions move through complex pathways inside the non-crystalline carbon, the rate of diffusion of lithium ions may slow down, thereby decreasing the rate of the electrochemical reaction at the negative electrode.

The mixing ratio of the core material to the coating material can be suitably selected in accordance with the coating method to be applied so that the amount of coating after appropriate work-up processes (removal of impurities and unreacted starting materials, etc.) is in the range described above.

Such a composite carbon can be evaluated by the evaluation method described above. The negative electrode active material disclosed herein is characterized by that it is formed of a composite carbon and has a D_{R≧0.2} of 20% or greater. When the D_{R≧0.2} is excessively smaller than this, at least either one of the maximum charging current density and the high-temperature storage stability may decrease or its balance may be disrupted. Although the upper limit of D_{R≧0.2} is not particularly limited, it can be usually around 95% or smaller.

The negative electrode active material (after coating) may have a specific surface area of, for instance, about 1 m²/g to 10 m²/g. Usually, it is preferably in a range of about 4 m²/g to 9 m²/g. With one having a D_{R≧0.2} of 20% or greater and a specific surface area within the preferable range, can be obtained a lithium-ion secondary battery with its maximum charging current density and high-temperature storage stability in a better balance. When the specific surface area is too small, sufficient current densities may not be obtained when charging and discharging. When the specific surface area is too large, the battery capacity may significantly decrease due to an increased irreversible capacity and so on. As the specific surface area, can be used a value measured by the nitrogen adsorption method.

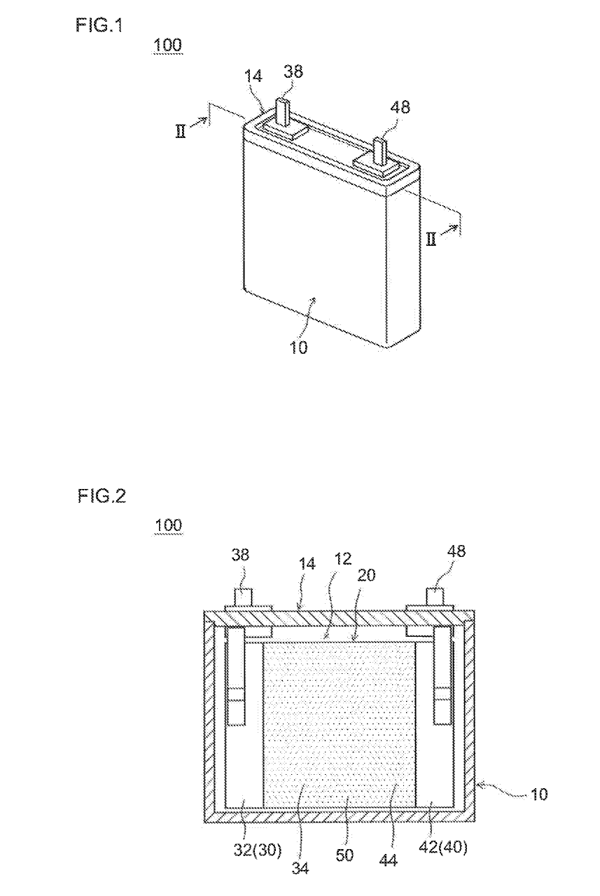

The present invention provides a lithium-ion secondary battery characterized by comprising a negative electrode containing a negative electrode active material disclosed herein. An embodiment of such a lithium-ion secondary battery is described in detail with an example of a lithium-ion secondary battery 100 (FIG. 1) having a configuration where an electrode body and a non-aqueous electrolyte solution are placed in a square battery case while the art disclosed herein is not limited to such an embodiment. In other words, the shape of the lithium-ion secondary battery disclosed herein is not particularly limited, and the materials, shapes, sizes, etc., of components such as the battery case, electrode body, etc., can be suitably selected in accordance with its intended use and capacity. For example, the battery case may have a cubic, flattened, cylindrical, or other shape. In the following drawings, all members and sites providing the same effect are indicated by the same reference numerals, and redundant descriptions may be omitted or abbreviated. Moreover, the dimensional relationships (of length, width, thickness, etc.) in each drawing do not represent actual dimensional relationships.

As shown in FIG. 1 and FIG. 2, a lithium-ion secondary battery 100 can be constructed by placing a wound electrode body 20 along with an electrolyte solution not shown in the drawing via an opening 12 into a flat box-shaped battery case 10 suitable for the shape of the electrode body 20, and closing the opening 12 of the case 10 with a lid 14. The lid 14 has a positive terminal 38 and a negative terminal 48 for connection to the outside, with the terminals partially extending out from the surface of the lid 14.

The electrode body 20 is formed into a flattened shape by overlaying and rolling up a positive electrode sheet 30 in which a positive electrode active material layer 34 is formed on the surface of a long sheet of a positive current collector 32 and a negative electrode sheet 40 in which a negative electrode active material layer 44 is formed on a long sheet of a negative current collector 42 along with two long sheets of separators 50, and laterally compressing the resulting wound body.

The positive electrode sheet 30 is formed to expose the positive current collector 32 on an edge along the sheet length direction, where the positive electrode active material layer 34 is not provided (or has been removed). Similarly, the negative electrode sheet 40 to be wound is formed to expose the negative current collector 42 on an edge along the sheet length direction, where the negative electrode active material is not provided (or has been removed). The positive terminal 38 is joined to the exposed edge of the positive current collector 32 and the negative terminal 48 is joined to the exposed edge of the negative current collector 42, respectively; to form electrical connections with the positive electrode sheet 30 and the negative electrode sheet 40 of the flattened wound electrode body 20. The positive and negative terminals 38 and 48 can be joined to their respective positive and negative current collectors 32 and 42, for example, by ultrasonic welding, resistance welding, and so on.

The negative electrode active material layer 44 can be formed, for instance, by applying to the negative current collector 42 a paste or slurry composition (negative electrode material mixture) obtained by dispersing in a suitable solvent a negative electrode active material disclosed herein as well as a binder, etc., and drying the applied composition. Although the amount of the negative electrode active material contained in the negative electrode material mixture is not particularly limited, it is preferably about 90 to 99% by mass, or more preferably 95 to 99% by mass.

As the binder, a suitable one can be selected for use from various polymers. One kind can be used solely or two or more kinds can be used in combination.

Examples include water-soluble polymers such as carboxymethyl cellulose (CMC), methyl cellulose (MC), cellulose acetate phthalate (CAP), hydroxypropyl methylcellulose (HPMC), hydroxypropyl methylcellulose phthalate (HPMCP), polyvinyl alcohols (PVA), etc.; fluorine containing resins such as polytetrafluoroethylene (PTFE), tetrafluoroethylene-perfluoroalkyl vinyl ether copolymers (PFA), tetrafluoroethylene-hexafluoropropylene copolymers (FEP), ethylene-tetrafluoroethylene copolymers (ETFE), etc.; water-dispersible polymers such as vinyl acetate copolymers, styrene-butadiene block copolymers (SBR), acrylic acid-modified SBR resins (SBR-based latexes), rubbers (gum arabic, etc.), etc.; oil-soluble polymers such as polyvinylidene fluoride (PVDF), polyvinylidene chloride (PVDC), polyethylene oxide (PEO), polypropylene oxide (PPO), polyethylene oxide-propylene oxide copolymers (PEO-PPO), etc.; and so on.

The amount of the binder added can be suitably selected in accordance with the type and amount of the negative electrode active material. For example, it can be about 1 to 5% by mass of the negative electrode material mixture.

As the negative current collector 42, can be preferably used a conductive material formed of a metal having good conductivity. For instance, copper or an alloy containing copper as the primary component can be used. The shape of the negative current collector 42 is not particularly limited as it may vary in accordance with the shape, etc., of the lithium-ion secondary battery, and it may have a variety of shapes such as a rod, plate, sheet, foil, mesh, and so on. In the present embodiment, a copper sheet is used as the negative current collector 42 and can be preferably used in a lithium-ion secondary battery 100 comprising a wound electrode body 20. In such an embodiment, for example, a copper sheet having a thickness of about 6 μm to 30 μm can be preferably used.

The positive electrode active material layer 34 can preferably be formed, for instance, by applying to the positive current collector 32 a paste or slurry composition (positive electrode material mixture) obtained by dispersing in a suitable solvent a positive electrode active material along with a conductive material, a binder, etc., as necessary, and by drying the composition.

As the positive electrode active material, a positive electrode material that is able to store and release lithium is used, and one kind, or two or more kinds of substances (e.g., layered oxides and spinel oxides) conventionally used in lithium-ion secondary batteries can be used without particular limitations. Examples include lithium-containing composite oxides such as lithium-nickel-based composite oxides, lithium-cobalt-based composite oxides, lithium-manganese-based composite oxides, lithium-magnesium-based composite oxides, and the like.

Herein, the scope of the lithium-nickel-based composite oxide encompasses oxides containing lithium (Li) and nickel (Ni) as constituent metal elements as well as oxides containing as constituent metal elements, in addition to lithium and nickel, at least one other kind of metal element (i.e., a transition metal element and/or a main group metal element other than Li and Ni) at a ratio roughly equal to or less than nickel (typically at a ratio less than nickel) based on the number of atoms. The metal element other than Li and Ni can be, for instance, one, two or more kinds of metal elements selected from a group consisting of cobalt (Co), aluminum (Al), manganese (Mn), chromium (Cr), iron (Fe), vanadium (V), magnesium (Mg), titanium (Ti), zirconium (Zr), niobium (Nb), molybdenum (Mo), tungsten (W), copper (Cu), zinc (Zn), gallium (Ga), indium (In), tin (Sn), lanthanum (La), and cerium (Ce). It is noted that the same applies also to the scopes of the lithium-cobalt-based composite oxide, the lithium-manganese-based composite oxide, and the lithium-magnesium-based composite oxide.

Alternatively, as the positive electrode active material, can be used an olivine lithium phosphate represented by the general formula LiMPO₄ (wherein M is at least one or more kinds of elements selected from Co, Ni, Mn and Fe; e.g., LiFePO₄, LiMnPO₄).

The amount of the positive electrode active material contained in the positive electrode material mixture can be, for example, about 80 to 95% by mass.

As the conductive material, can be preferably used a powdered conductive material such as carbon powder, carbon fibers, and so on. As the carbon powder, various kinds of carbon black such as acetylene black, furnace black, Ketjen black, graphite powder and the like are preferred. One kind of conductive material can be used solely, or two or more kinds can be used in combination.

The amount of the conductive material contained in the positive electrode material mixture may be suitably selected in accordance with the kind and amount of the positive electrode active material, and for instance, it can be about 4 to 15% by mass.

As the binder, of those listed early for the negative electrode, can be used one kind alone, or two or more kinds in combination. The amount of the binder added can be suitably selected in accordance with the kind and amount of the positive electrode active material, and for instance, it can be about 1 to 5% by mass of the positive electrode material mixture.

As the positive current collector 32, can be preferably used a conductive material firmed of a metal having good conductivity. For example, can be used aluminum or an alloy containing aluminum as the primary component. The shape of the positive current collector 32 is not particularly limited as it may vary in accordance with the shape, etc., of the lithium-ion secondary battery, and it may have a variety of shapes such as a rod, plate, sheet, foil, mesh, and so on. In the present embodiment, an aluminum sheet is used as the positive current collector 32 and can be preferably used in a lithium-ion secondary battery 100 comprising a wound electrode body 20. In such an embodiment, for example, an aluminum sheet having a thickness of about 10 μm to 30 μm a can be preferably used.

The non-aqueous electrolyte solution comprises a supporting salt in a non-aqueous solvent (organic solvent). As the supporting salt, a lithium salt used as a supporting salt in general lithium-ion secondary batteries can be suitably selected for use. Examples of such a lithium salt include LiPF₆, LiBF₄, LiClO₄, LiAsF₆, Li(CF₃SO₂)₂N, LiCF₃SO₃, and the like. One kind of such a supporting salt can be used solely, or two or more kinds can be used in combination. LiPF₆ can be given as an especially preferable example. It is preferable to prepare the non-aqueous electrolyte solution to have a supporting salt concentration within a range of, for instance, 0.7 mol/L to 1.3 mol/L.

As the non-aqueous solvent, an organic solvent used in general lithium-ion secondary batteries can be suitably selected for use. Examples of especially preferable non-aqueous solvents include carbonates such as ethylene carbonate (EC), dimethyl carbonate (DMC), ethyl methyl carbonate (EMC), diethyl carbonate (DEC), vinylene carbonate (VC), and propylene carbonate (PC), and so on. Of these organic solvents, one kind can be used solely, or two or more kinds can be used in combination. For example, a mixture of EC, DMC, and EMC, or a mixture of these and VC can be preferably used.

In an embodiment of the lithium-ion secondary battery disclosed herein, the non-aqueous electrolyte solution comprises VC. The amount of VC added is preferably about 0.1 to 3% by mass (more preferably 0.3 to 1% by mass) of the non-aqueous solvent. According to such a composition, the high-temperature storage stability can be increased while keeping the maximum charging current density at a high level. VC functions to stabilize an SET (Solid Electrolyte Interface) film on the negative electrode surface. Since an SEI film is formed by side reactions (reductive decompositions of the non-aqueous solvent, supporting salt, etc.) on the negative electrode, the condition (evenness, etc.) of the formed SEI film can also be affected, as described above, by differences in the crystallinities of the active material particle surfaces. Therefore, use of the D_{R≧0.2} as an index is effective also to steadily obtain the effect of VC addition to increase the high-temperature storage stability. When the amount of added VC is too small, the effect to increase the high-temperature storage stability may not be sufficient. When the amount of added VC is too large, the amount of decomposed VC may increase when stored at a high temperature and the high-temperature storage stability may turn out to decrease.

The separator 50 is a sheet placed between the positive electrode sheet 30 and the negative electrode 40 so as to be in contact with both the positive electrode active material layer 34 of the positive electrode sheet 30 and the negative electrode active material layer 44 of the negative electrode sheet 40. It functions to prevent a short circuit associated with direct contact between the two electrode active material layers 34 and 44 on the positive electrode sheet 30 and the negative electrode sheet 40. It also functions to form conductive paths (conductive pathways) between the electrodes, with the pores of the separator 50 having been impregnated with the electrolyte solution. As such a separator 50, a conventional separator can be used without particular limitations. For example, a porous sheet of a resin (micro-porous resin sheet) can be preferably used. A porous sheet of a polyolefin resin such as polyethylene (PE), polypropylene (PP), polystyrene, etc., is preferred. In particular, can be used preferably a PE sheet, a PP sheet, a multi-layer sheet having overlaid PE and PP layers, or the like. The thickness of the separator is preferably set within a range of about 10 μm to 40 nm, for example.

As described earlier, the method for negative electrode active material evaluation disclosed herein can sort out negative electrode active materials formed of composite carbons, using the D_{R≧0.2} as an index. A negative electrode active material sorted out this way allows steady fabrication of lithium-ion secondary batteries with a prescribed level of performance (e.g., low-temperature maximum charging current density and high-temperature storage stability). Such a method for negative electrode active material evaluation can be incorporated into a final stage of procedures for manufacturing a negative electrode active material formed of a composite carbon as a part of quality inspection procedures. In the quality inspection procedures, in addition to the D_{R≧0.2}, other parameters (specific surface area, particle diameter, etc.) may be used as well.

The art disclosed herein provides a method for producing a negative electrode active material formed of a composite carbon, with the method being characterized by comprising an inspection procedure that comprises at least sorting out a negative electrode active material having a D_{R≧0.2} of 20% or greater when determined by the evaluation method described above.

According to a negative electrode active material disclosed herein, because the activity can be controlled more precisely, high-performance lithium-ion secondary batteries can be steadily produced. Thus, the art disclosed herein also provides a method for producing a lithium-ion secondary battery, with the method being characterized by using a negative electrode comprising a negative electrode active material disclosed herein. It provides a method for producing a lithium-ion secondary battery comprising, for instance, the following steps:

(W) determining the D_{R≧0.2};

(X) judging the acceptability;

(Y) fabricating a negative electrode using an acceptable material; and

(Z) constructing a battery using the negative electrode;

In the step (W), the D_{R≧0.2} may be measured for every subject material, or data of a past measurement may be applied.

Several embodiments relevant to the present invention are described below although this is not to limit the present invention to these embodiments. In the following explanation, the terms “parts” and “%” are based on the mass unless specifically stated otherwise.

### Example 1

Graphite particles (core material) were subjected to a CVD process to obtain a negative electrode active material formed of a composite carbon having a coating amount of 2% and a specific surface area of 1.9 m²/g.

### Example 2

Graphite particles (core material) and a coating material were mixed and sintered to obtain a negative electrode active material firmed of a composite carbon having a coating amount of 2% and a specific surface area of 2 m²/g.

### Example 3

Graphite particles (core material) and a coating material were mixed and sintered to obtain a negative electrode active material formed of a composite carbon having a coating amount of 2% and a specific surface area of 3.6 m²/g.

### Example 4

Graphite particles (core material) were subjected to a CVD process to obtain a negative electrode active material formed of a composite carbon having a coating amount of 2% and a specific surface area of 3.6 m²/g.

### Example 5

Graphite particles (core material) and a coating material were mixed and sintered to obtain a negative electrode active material formed of a composite carbon having a coating amount of 2% and a specific surface area of 3.7 m²/g.

### Example 6

Graphite particles (core material) were subjected to a CVD process to obtain a negative electrode active material formed of a composite carbon having a coating amount of 2% and a specific surface area of 4.2 m²/g.

### Example 7

Was obtained a negative electrode active material formed of a composite carbon having a coating amount of 2% and a specific surface area of 4.3 m²/g.

### Example 8

Was obtained a negative electrode active material formed of a composite carbon having a coating amount of 2% and a specific surface area of 4.5 m²/g.

### Example 9

Was obtained a negative electrode active material formed of a composite carbon having a coating amount of 2% and a specific surface area of 5.3 m²/g.

### Example 10

Was obtained a negative electrode active material formed of a composite carbon having a coating amount of 2% and a specific surface area of 6.2 m²/g.

### Example 11

Was obtained a negative electrode active material formed of a composite carbon having a coating amount of 2% and a specific surface area of 6.3 m²/g.

### Example 12

Was obtained a negative electrode active material formed of a composite carbon having a coating amount of 2% and a specific surface area of 6.3 m²/g.

### Example 13

Was obtained a negative electrode active material formed of a composite carbon having a coating amount of 2% and a specific surface area of 8.1 m²/g.

### Example 14

Was obtained a negative electrode active material formed of a composite carbon having a coating amount of 2% and a specific surface area of 8.9 m²/g.

### Example 15

Was obtained a negative electrode active material formed of a composite carbon having a coating amount of 2% and a specific surface area of 9.9 m²/g.

### Example 16

Was prepared the same negative electrode active material as Example 7.

### Example 17

Was prepared the same negative electrode active material as Example 8.

### Example 18

Was prepared the same negative electrode active material as Example 12.

### Example 19

Was prepared the same negative electrode active material as Example 13.

The following evaluations and measurements were carried out on the respective negative electrode active materials of Examples 1 to 19.

### [Microscopic Raman Analysis]

A 0.1 mg sample of the negative electrode active material of each Example was subjected to 125 runs of microscopic Raman analysis using a microscopic laser Raman system (model “Nicolet Almega XR” available from Thermo Fisher Scientific, Inc.) at a wavelength of 532 nm for a measurement time of 30 seconds, at 2 μm resolution and 100% laser output; and the R value for each run was determined. As the D_{R≧0.2}, was calculated the percentage of the number of runs where the R value was equal to or greater than 0.2 relative to the total number of analysis runs. With respect to the results of the microscopic Raman analysis on Example 12, the R values up to the 100th run as well as the DR_{R≧0.2} are shown in Table 1.

TABLE 1

| | Number of |
|---|---|
| R value | analysis runs |
| 0.0095 | 0 |
| 0.0395 | 5 |
| 0.0695 | 1 |
| 0.0995 | 7 |
| 0.1295 | 4 |
| 0.1595 | 1 |
| 0.1895 | 7 |
| 0.2195 | 4 |
| 0.2495 | 5 |
| 0.2795 | 1 |
| 0.3095 | 6 |
| 0.3395 | 2 |
| 0.3695 | 4 |
| 0.3995 | 6 |
| 0.4295 | 0 |
| 0.4595 | 3 |
| 0.4895 | 5 |
| 0.5195 | 1 |
| 0.5495 | 9 |
| 0.5795 | 3 |
| 0.6095 | 6 |
| 0.6395 | 3 |
| 0.6695 | 3 |
| 0.6995 | 1 |
| 0.7295 | 4 |
| 0.7595 | 2 |
| 0.7895 | 2 |
| 0.8195 | 0 |
| 0.8495 | 0 |
| 0.8795 | 2 |
| 0.9095 | 2 |
| 0.9395 | 0 |
| 0.9695 | 0 |
| 0.9995 | 0 |
| 1.0295 | 0 |
| 1.0595 | 1 |
| 1.0895 | 0 |

D_{R≧0.2} = 75%

### [Specific Surface Area]

The specific surface areas of the respective negative electrode active materials were measured by nitrogen adsorption, using a specific surface area analyzer (model “MACSORB HM MODEL-1200” available from Mountech Co., Ltd.).

With the respective negative electrode active materials of Examples 1 to 19, in accordance with the following procedures, were fabricated laminated cell batteries and 18650 batteries (in cylindrical shape of 18 mm diameter, 65 mm high).

### [Laminated Cell Battery]

As a negative electrode material mixture, a negative electrode active material, SBR and CMC were mixed at a mass ratio of 98:1:1 and NV of 45% in ion-exchanged water to prepare a slurry composition. This negative electrode material mixture was applied to each face of a 10 μm thick copper foil so that the total amount applied to both faces was 8 mg/cm². This was dried and then pressed to prepare a negative electrode sheet. From this negative electrode sheet, was cut out a square piece of 5 cm by 5 cm having a 10 mm wide strip portion at one corner. The applied material was removed from each face of the strip portion to expose the copper foil and form a terminal portion, whereby a negative electrode sheet having a terminal was obtained.

As a positive electrode material mixture, LiNi_{1/3}Co_{1/3}Mn_{1/3}O₂, acetylene black (AB) and polyvinylidene fluoride (PVDF) were mixed at a mass ratio of 85:10:5 and NV of 50% in N-methyl-2-pyrrolidone (NMP) to prepare a slurry composition. This composition was applied to each face of a 15 μm thick aluminum foil so that the total amount applied to both faces was 16.7 mg/cm² (based on solid contents). This was dried and then pressed to prepare a positive electrode sheet. This positive electrode sheet was processed into a piece having the same size and shape as the negative electrode sheet to obtain a positive electrode sheet having a terminal.

As the non-aqueous electrolyte solution of Examples 1 to 15, was used a 1 mol/L (1 M) LiPF₆ solution prepared with a mixed solvent of EC, DMC and EMC at a volume ratio of 1:1:1. As the non-aqueous electrolyte solution of Examples 16 to 19, was used a 1 M LiPF₆ solution prepared with a solvent that had been obtained by further adding 0.5 part of VC to 100 parts of the mixed solvent.

The positive electrode sheet and the negative electrode sheet were overlaid via a 2.5 μm thick porous polyethylene sheet so that the two terminals were placed symmetrically at two ends on one side. The resultant was wrapped in a laminating film so that the two terminals were partially outside of the film. To this, the non-aqueous electrolyte solution described above was put in and the film was sealed to construct a laminated cell battery having a capacity of 45 mAh.

### [18650 Battery]

The negative electrode material mixture was applied to each face of a 10 μm thick copper foil strip so that the total amount applied to both faces was 8 mg/cm² (based on NV). This was dried and then pressed to a total thickness of about 65 μm to obtain a negative electrode sheet.

The positive electrode material mixture was applied to each face of a 15 μm thick aluminum foil strip so that that the total amount applied to both faces was 24 mg/cm² (based on NV). This was dried and then pressed to a total thickness of about 84 μm to obtain a positive electrode sheet.

These negative electrode sheet and positive electrode sheet were overlaid along with two long porous polyethylene sheets and the resulting laminate was rolled along the length. The resulting wound electrode body was placed into a cylindrical case along with the non-aqueous electrolyte solution (with added VC only in Examples 16 to 19) described above and the case was sealed to construct a 18650 battery 200 (FIG. 7) having a capacity of 800 mAh.

### [Conditioning Process]

Each battery was subjected to constant-current (CC) charging at a rate of 1/10 C for 3 hours followed by three cycles of charging to 4.1 V at a rate of 1/3 C and discharging to 3.0 V at a rate of 1/3 C. One C indicates an amount of current that provides a fill charge or discharge in one hour.

### [Initial Capacity]

At a temperature of 25° C., each battery was subjected to CC charging at a rate of 1 C to have a voltage across terminals of 4.1 V followed by constant voltage (CV) charging to a total charging time of 2.5 hours. After a 10-minute break from the completion of charging, at the same temperature, it was subjected to CC discharging from 4.1 V to 3.0 V at a rate of 0.33 C followed by CV discharging to a total discharging time of 4 hours. At the same time, the discharge capacity was measured as the initial capacity of each battery.

### [Maximum Charging Current Density]

After the initial capacity measurement, each battery was subjected to CC charging to have a voltage across terminals of 4.1 V at a rate of 1 C followed by CV charging to a SOC of 60%. The battery was placed between two plates and held under a load of 350 kgf. At 0° C., this was subjected to a first charge-discharge cycle of CC charging for 10 seconds at a current density (determined by dividing the applied current value by the electrode surface area) of 14.0 mA/cm² followed by a 10 minute break followed by CC discharging for 10 seconds at a current density of 14.0 mA/cm² followed by another 10 minute break. After this cycle was repeated 250 times, the discharge capacity was measured in the same way as the initial capacity measurement.

The current density was increased by an increment of 1.2 mA/cm² at every 250 cycles and the discharge capacity was measured after 250 cycles at each current density

As the capacity retention (%), was determined the percentage of the discharge capacity after each cycle to the initial capacity. When the capacity retention decreased by 3% relative to the value after the preceding cycle, the measurement was stopped; and the current density in the preceding cycle relative to the last measured cycle was taken as the maximum charging current density.

### [High-Temperature Storage Stability]

The 18650 buttery of each Example brought to a SOC of 80% after conditioning was subjected at room temperature (23° C.) to CC discharging at a rate of 1/3 C to a SOC of 0%, and the discharge capacity was measured as the initial capacity at the same time. It was then brought back to a SOC of 80% at a rate of 1/3 C and stored at 60° C. for 30 days. After this, the post-storage discharge capacity was measured in the same way as the initial capacity measurement. As the capacity retention (%), was determined the percentage of the post-storage discharge capacity to the initial capacity.

With respect to the negative electrode active materials and batteries of Examples 1 to 19, the results of the measurements are shown in Table 2.

TABLE 2

| | | | | | Capacity |
|---|---|---|---|---|---|
| | | | | maximum | retention |
| | | | | charging | after storage |
| | | | Specific | current | at high |
| | | D_{R≧0.2} | surface area | density | temperature |
| Example | added VC | (%) | (m²/g) | (mA/cm²) | (%) |
| 1 | None | 95 | 1.9 | 12.8 | 86.7 |
| 2 | None | 13 | 2 | 10.4 | 85.2 |
| 3 | None | 9.2 | 3.6 | 14 | 83.9 |
| 4 | None | 89 | 3.6 | 18.8 | 85.5 |
| 5 | None | 19 | 3.7 | 15.2 | 84.2 |
| 6 | None | 50 | 4.2 | 20 | 85.4 |
| 7 | None | 18 | 4.3 | 16.4 | 83.7 |
| 8 | None | 55 | 4.5 | 22.4 | 84.1 |
| 9 | None | 39 | 5.3 | 24.8 | 83.4 |
| 10 | None | 33 | 6.2 | 26 | 82.4 |
| 11 | None | 34 | 6.3 | 26 | 82.1 |
| 12 | None | 75 | 6.3 | 26 | 82.8 |
| 13 | None | 29 | 8.1 | 27.2 | 81.1 |
| 14 | None | 31 | 8.9 | 28.4 | 80.9 |
| 15 | None | 28 | 9.9 | 28.4 | 76.2 |
| 16 | Present | 18 | 4.3 | 15.2 | 85.4 |
| 17 | Present | 55 | 4.5 | 22.4 | 87.3 |
| 18 | Present | 75 | 6.3 | 26 | 85.6 |
| 19 | Present | 29 | 8.1 | 27.2 | 83.6 |

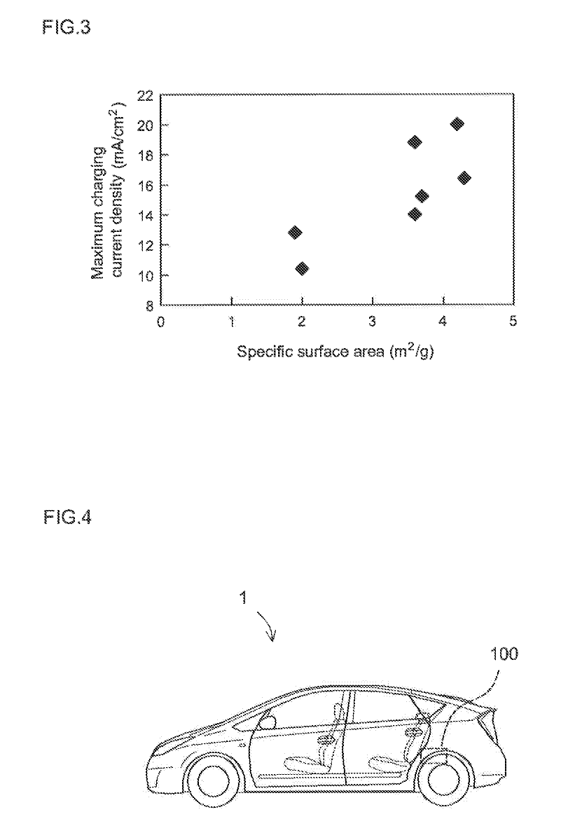

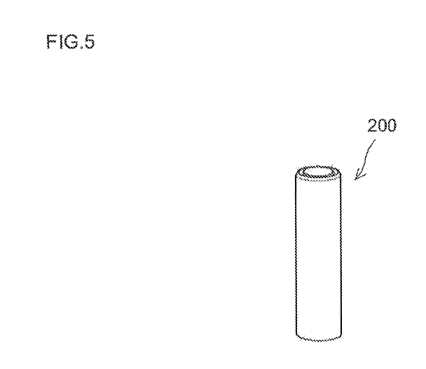

As shown in Table 2, it was found that even with approximately the same specific surface area values, as the D_{R≧0.2} increased, the maximum charging current density and/or the high-temperature storage stability (the capacity retention after stored at a high temperature) tended to increase. For example, as shown in FIG. 3 as well, of Examples 1 and 2 having approximately the same specific surface area values, Example 1 with a D_{R≧0.2} of 20% or greater had both higher maximum charging current density and greater high-temperature storage stability as compared to Example 2 with a D_{R≧0.2} of less than 20%. In particular, with respect to the maximum charging current density, a significant difference was found such that Example 1 was greater by 23% than Example 2. Similarly, of Examples 3 to 5 having approximately the same specific surface area values, Example 4 having a D_{R≧0.2} of 20% or greater had both higher maximum charging current density and greater high-temperature storage stability as compared to Examples 3 and 5 having D_{R≧0.2} values of less than 20%. With respect to Examples 6 and 7, although both had approximately the same specific surface area values, Example 6 having a D_{R≧0.2} of 20% or greater had both higher maximum charging current density and greater high-temperature storage stability as compared to Example 7 having a D_{R≧0.2} of less than 20%. The maximum charging current density of Example 6 was higher by 22% than that of Example 7.

Of Examples 1 to 19, Examples 6, 8 to 14, and 17 to 19 each having a specific surface area within the range of 4 m²/g to 9 m²/g and a D_{R≧0.2} of 20% or greater, achieved high levels of the two properties in a good balance, with the maximum charging current density being 20 mA/cm² (44% of the battery capacity) or greater and the post-storage capacity retention of 80% or greater.

In comparison of Examples 16 to 19 with added VC to Examples 7, 8, 12, and 13 with no added VC, when the D_{R≧0.2} was less than 20% (Examples 7, 16), as a result of VC addition, the high-temperature storage stability increased although the maximum charging current density decreased. In contrast to this, when the D_{R≧0.2} was 20% or greater (Examples 8, 17; Examples 12, 18; Examples 13, 19), by the addition of VC, the high-temperature storage stability was increased without a decrease in the maximum charging current density.

Although specific embodiments of the present invention have been described in detail above, these are merely for illustrations and do not limit the scope of the claims. The art according to the claims includes various modifications and changes of the specific embodiments illustrated above.

### REFERENCE SIGNS LIST

1 vehicle
20 wound electrode body
30 positive electrode sheet
32 positive current collector
34 positive electrode active material layer
38 positive terminal
40 negative electrode sheet
42 negative current collector
44 negative electrode active material layer
48 negative terminal
50 separator
100, 200 lithium-ion secondary battery

1. A method for evaluating, as a negative electrode active material, a composite carbon comprising a low-crystalline carbon material at least partially on surfaces of particles of a high-crystalline carbonaceous substance, the method comprising:
running microscopic Raman analysis at a wavelength of 532 nm n times on a sample of the negative electrode active material (wherein n is 20 or more);
with respect to a Raman spectrum obtained in each microscopic Raman analysis run, determining the ratio of its D-band intensity ID to its G-band intensity I_{G}, R (I_{D}/I_{G});
determining the number of analysis runs, m, where the R value was equal to or greater than 0.2; and
as the distribution of R values equal to or greater than 0.2 (D_{R≧0.2}), determining the ratio of m to n (m/n).

2. A negative electrode active material formed of a composite carbon comprising low-crystalline carbon films on surfaces of particles of a high-crystalline carbon, characterized by that the distribution of R values equal to or greater than 0.2 determined by the method according to claim 1 is 20% or greater.

3. The negative electrode active material according to claim 2, characterized by further having a nitrogen adsorption specific surface area in a range of 4 m²/g to 9 m²/g.

4. A lithium-ion secondary battery comprising a negative electrode comprising the negative electrode active material according to claim 2, a positive electrode comprising a positive electrode active material, and a non-aqueous electrolyte solution.

5. The lithium-ion secondary battery according to claim 4, characterized by that the non-aqueous electrolyte solution comprises vinylene carbonate.

6. A vehicle comprising the lithium-ion secondary battery according to claim 4.

7. A vehicle comprising the lithium-ion secondary battery according to claim 5.

8. A lithium-ion secondary battery comprising a negative electrode comprising the negative electrode active material according to claim 3, a positive electrode comprising a positive electrode active material, and a non-aqueous electrolyte solution.

9. The lithium-ion secondary battery according to claim 8, characterized by that the non-aqueous electrolyte solution comprises vinylene carbonate.

10. A vehicle comprising the lithium-ion secondary battery according to claim 8.

11. A vehicle comprising the lithium-ion secondary battery according to claim 9.
